(19) United States
(12) Patent Application Publication
(10) Pub. No.: US 2026/0005386 A1
(43) Pub. Date: Jan. 1, 2026

(54) VENT DUCT CONFIGURATION FOR BATTERY PACK

(71) Applicant: Ford Global Technologies, LLC, Dearborn, MI (US)

(72) Inventor: Patrick Roxin, Livonia, MI (US)

(21) Appl. No.: 18/760,125

(22) Filed: Jul. 1, 2024

(51) Int. Cl. H01M 50/358; B60R 16/033; H01M 50/204; H01M 50/249; H01M 50/333; H01M 50/342; H01M 50/367

(52) U.S. Cl. CPC H01M 50/358; H01M 50/204; H01M 50/249; H01M 50/333; H01M 50/3425; H01M 50/367; B60R 16/033; H01M 2200/20; H01M 2220/20

(57) ABSTRACT

A battery pack may include an enclosure assembly providing an interior that houses at least one battery array. The battery pack may include a pressure relief valve configured to selectively communicate a flow of vent byproducts from the interior of the enclosure assembly to an exterior of the enclosure assembly via an opening. Further, the battery pack may include a vent duct including a wall. When vent byproducts are communicated through the opening, the wall lies in a plane oblique to a centerline of the opening.

### TECHNICAL FIELD

This disclosure relates generally to electrified vehicles, and more specifically relates to a vent duct configuration for a battery pack.

### BACKGROUND

A high voltage traction battery pack typically powers the electric machines and other electrical loads of an electrified vehicle. The traction battery pack includes a plurality of battery cells.

### SUMMARY

In some aspects, the techniques described herein relate to a battery pack, including: an enclosure assembly providing an interior that houses at least one battery array; a pressure relief valve configured to selectively communicate a flow of vent byproducts from the interior of the enclosure assembly to an exterior of the enclosure assembly via an opening; and a vent duct including a wall, wherein, when vent byproducts are communicated through the opening, the wall lies in a plane oblique to a centerline of the opening.

In some aspects, the techniques described herein relate to a battery pack, wherein, when vent byproducts are communicated through the opening, the wall is transverse to the centerline of the opening.

In some aspects, the techniques described herein relate to a battery pack, wherein the wall provides at least a portion of the pressure relief valve and at least a portion of the vent duct.

In some aspects, the techniques described herein relate to a battery pack, wherein: the wall is configured as a moveable flap and is moveable relative to the opening, the wall covers the opening when vent byproducts are not communicated through the opening, and the wall uncovers the opening when vent byproducts are communicated through the opening.

In some aspects, the techniques described herein relate to a battery pack, wherein, when vent byproducts are not communicated through the opening, the wall lies in a plane substantially perpendicular to the centerline of the opening.

In some aspects, the techniques described herein relate to a battery pack, further including: at least one retention clip configured to resist movement of the wall when vent byproducts are not communicated through the opening, and wherein, in order for vent byproducts to be communicated through the opening, the pressure of the vent byproducts must overcome the resistance of the at least one retention clip.

In some aspects, the techniques described herein relate to a battery pack, further including: a hinge assembly configured to permit the wall to rotate as vent byproducts are communicated through the opening.

In some aspects, the techniques described herein relate to a battery pack, wherein the hinge assembly is configured to restrict movement of the wall beyond a threshold rotation amount.

In some aspects, the techniques described herein relate to a battery pack, wherein: the vent duct includes a first side wall and a second side wall, the first and second side walls lie in respective planes substantially parallel to the centerline of the opening, and the wall is arranged between the first and second side walls and is moveable relative to the first and second side walls.

In some aspects, the techniques described herein relate to a battery pack, wherein, when vent byproducts are communicated through the opening, side edges of the wall directly contact the first and second side walls.

In some aspects, the techniques described herein relate to a battery pack, wherein, when vent byproducts are communicated through the opening, a catch holds the wall in a position such that the wall lies in a plane oblique to a centerline of the opening.

In some aspects, the techniques described herein relate to a battery pack, wherein, when vent byproducts are communicated through the opening and the catch holds the wall in the position such that the wall lies in a plane oblique to a centerline of the opening, the catch prevents movement of the wall toward the opening.

In some aspects, the techniques described herein relate to a battery pack, wherein the wall is formed separately from the pressure relief valve and is configured to remain stationary while vent byproducts are communicated through the opening.

In some aspects, the techniques described herein relate to a battery pack, wherein: the vent duct includes a first side wall and a second side wall, the first and second side walls are fixed to the wall and arranged on opposite sides of the wall, the first and second side walls lie in respective planes substantially parallel to the centerline of the opening.

In some aspects, the techniques described herein relate to a battery pack, wherein the pressure relief valve includes one of a spring valve and a membrane.

In some aspects, the techniques described herein relate to a battery pack, wherein the vent duct is configured such that the wall guides the vent byproducts that flow out of the opening in a direction away from the centerline of the opening.

In some aspects, the techniques described herein relate to a vent duct for a battery pack, including: a wall configured such that, when vent byproducts are communicated through an opening of an enclosure assembly of the battery pack, the wall lies in a plane oblique to a centerline of the opening.

In some aspects, the techniques described herein relate to a vent duct, wherein the wall is transverse to the centerline of the opening.

In some aspects, the techniques described herein relate to a vent duct, wherein either (i) the wall is formed separately from a pressure relief valve and is configured to remain stationary while vent byproducts are communicated through the opening, or (ii) the wall provides at least a portion of a pressure relief valve and at least a portion of the vent duct.

In some aspects, the techniques described herein relate to a method, including: guiding vent byproducts communicated through an opening of an enclosure assembly of a battery pack in a direction away from a centerline of the opening using a wall lying in a plane oblique to the centerline of the opening.

### BRIEF DESCRIPTION OF THE DRAWINGS

FIG. 1 illustrates a side view of an electrified vehicle having a traction battery pack.

FIG. 2 is a perspective view of the battery pack of FIG. 1.

FIG. 3 illustrates a section view through the battery pack of FIG. 2.

FIG. 4 illustrates an example pressure relief valve in a closed position.

FIG. 5 illustrates the example pressure relief valve in an open position.

FIG. 6 illustrates additional detail of an example hinge assembly.

FIG. 7 illustrates another embodiment of the example pressure relief valve including a duct with first and second side walls. In FIG. 7, the pressure relief valve is in the closed position.

FIG. 8 illustrates the embodiment of FIG. 7 with the pressure relief valve in the open position.

FIG. 9 illustrates another pressure relief valve with another example duct assembly.

FIG. 10 illustrates a first type of pressure relief valve configured for use with the duct assembly of FIG. 9.

FIG. 11 illustrates a second type of pressure relief valve configured for use with the duct assembly of FIG. 9.

### DETAILED DESCRIPTION

This disclosure relates generally to electrified vehicles, and more specifically relates to a vent duct configuration for a battery pack. A corresponding method is also disclosed. The disclosed design reduces packaging requirements and is configured to guide vent byproducts in a desired direction. These and other benefits will be appreciated from the following description.

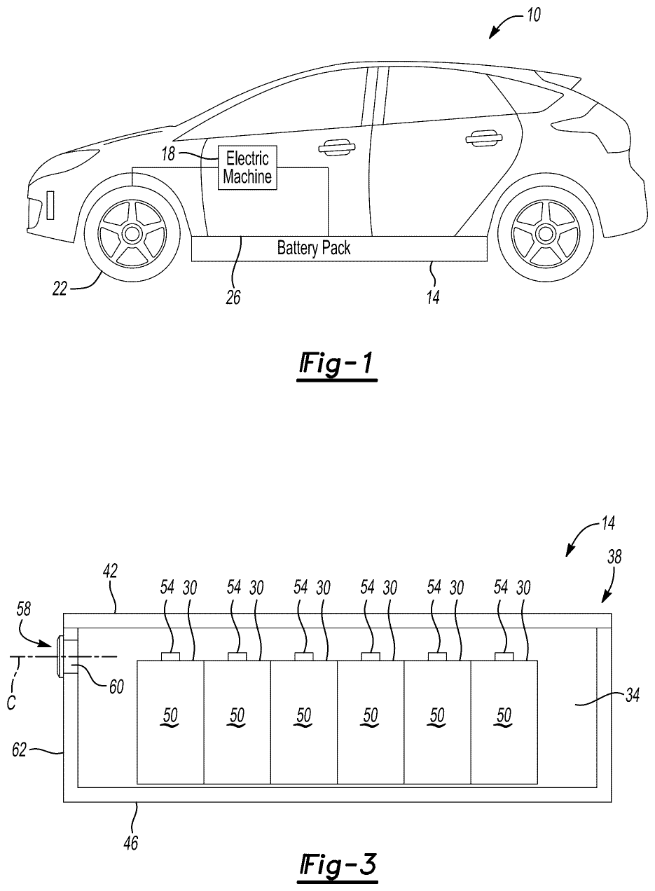

With reference to FIG. 1, an electrified vehicle 10 includes a traction battery pack 14 (“battery pack 14”), an electric machine 18, and wheels 22. The battery pack 14 powers the electric machine 18, which converts electric power to torque to drive the wheels 22.

The example electrified vehicle 10 is an all-electric vehicle. In other examples, the electrified vehicle 10 is a hybrid electric vehicle, which selectively drives wheels using torque provided by an internal combustion engine instead, or in addition to, an electric machine. Generally, the electrified vehicle 10 could be any type of vehicle having a battery pack.

In the example of FIG. 1, the battery pack 14 is secured to an underbody 26 of the electrified vehicle 10. However, the battery pack 14 could be located elsewhere on the electrified vehicle 10 in other examples.

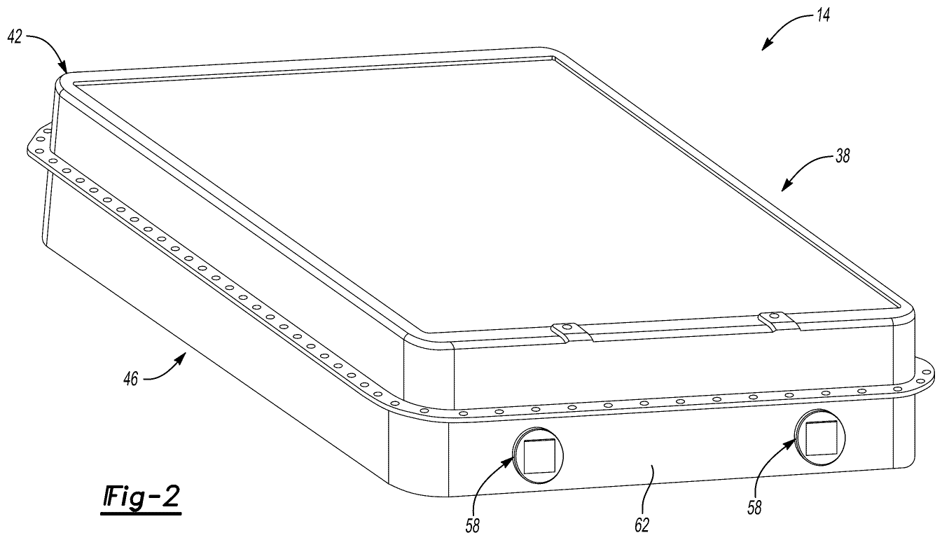

With reference to FIGS. 2 and 3, the battery pack 14 includes one or more battery arrays 30 held within an interior area 34 provided by an enclosure assembly 38. The battery arrays 30 are capable of outputting electrical power to power the electric machine 18 and/or other electrical loads of the electrified vehicle 10 (see FIG. 1).

The enclosure assembly 38 houses the battery arrays 30. The enclosure assembly 38 includes a cover 42 and a tray 46. The cover 42 can be secured (e.g., bolted, welded, adhered, etc.) to the tray 46 to provide the interior area 34. The cover 42 and tray 46 can be polymer-based. Alternatively, the cover 42, the tray 46, or both can be a metal or metal alloy.

Each of the example battery arrays 30 includes a plurality of battery cells 50 that are stacked side-by-side.

In this example, the battery cells 50 each include a vent 54. The battery pack 14 can experience a thermal event when pressure within one of the battery cells 50 increases due to, for example, over-charging conditions or over-discharging conditions. The pressure increase can cause the vent 54 release a flow of vent byproducts into the interior area 34. The vent byproducts can include gases, effluent particles, and constituent materials, for example.

The battery pack 14 is equipped with features for venting the vent byproducts from the enclosure assembly 38 to an area outside the battery pack 14.

The battery pack 14 includes at least one pressure relief valve 58 (sometimes referred to as pressure relief devices). While the pressure relief valve 58 may include a spring, such as a valve spring, the term pressure relief valve is used herein to refer to a device for controlling the passage of fluid or air, and to specifically refer to such a device that is configured to provide pressure relief for the battery pack 14. The term pressure relief valve is not used to imply that the pressure relief valve 58 has any certain structures, such as a valve spring.

In the embodiment of FIG. 2, the battery pack 14 includes two pressure relief valves 58. The pressure relief valves 58 are disposed in a wall 62 of the enclosure assembly 38. The pressure relief valves 58 can be disposed in the cover 42, the tray 46, or both. Each pressure relief valve 58 is configured to selectively cover and uncover an opening in the enclosure assembly 38. For instance, pressure relief valve 58 in FIG. 3 is configured to selectively cover and uncover opening 60.

Each pressure relief valve 58 is configured to transition from a closed position and an open position when pressure within the interior area 34 increases due to one or more battery cells 50 venting during a thermal event. When in the closed position, the pressure relief valve 58 blocks flow from the interior area 34. When in the open position, the pressure relief valve 58 permits the flow of vent byproducts to move from the interior area 34 to an area outside the battery pack 14.

This disclosure also relates to a vent duct configured to guide the vent byproducts that are communicated through the openings (e.g., opening 60) corresponding to the pressure relief valves 58. The disclosed vent ducts guide vent byproducts in a direction away from the centerlines (e.g., centerline C) of the corresponding openings. The vent ducts may include a central wall that provides a portion of the vent duct and a portion of the pressure relief valve. Alternatively, the vent duct may include a central wall that is formed separately from the pressure relief valve, as will be discussed below.

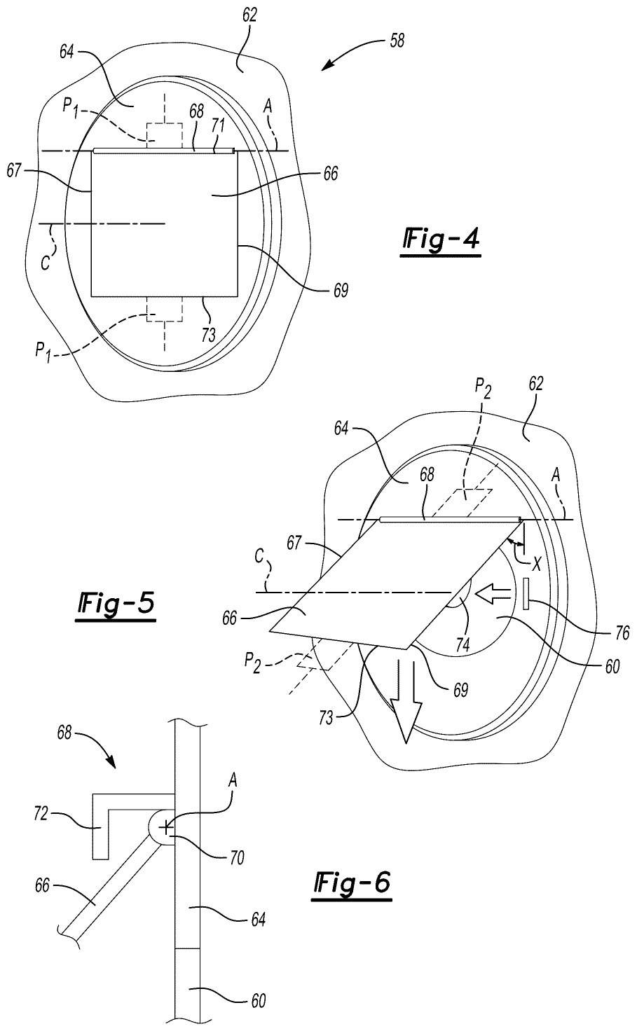

FIG. 4 illustrates a first example pressure relief valve 58 in the closed position. FIG. 5 illustrates the first example pressure relief valve 58 in the open position. It should be understood that the battery pack 14 can include one or more pressure relief valves and/or vent ducts configured according to the below-discussed embodiments.

The pressure relief valve 58 includes a base 64 configured to facilitate attachment of the pressure relief valve 58 to the wall 62. The base 64 could be secured to the wall 62 via a twist-lock style connection, for example.

The pressure relieve valve 58 further includes a wall 66. The wall 66 may be referred to as a central wall. In this embodiment, the wall 66 is configured as a moveable flap. The wall 66 includes a first side edge 67, a second side edge 69 opposite the first side edge 67, a first end 71, and a second end 73 opposite the first end 71. The wall 66 is substantially rectangular-shaped in this example. The wall 66 exhibits a constant thickness, in this example. The wall 66 is sized so as to completely cover the opening 60 when the pressure relief valve 58 is in the closed position.

The wall 66 is mounted relative to the base 64 via a hinge assembly 68. The hinge assembly 68 is configured to couple to the wall 66 adjacent the first end 71 and to facilitate rotation of the wall 66 about an axis A, which is substantially parallel to the first end 71. The hinge assembly 68 is further configured to limit rotation of the wall 66 beyond a threshold rotation amount X (FIG. 5) when vent byproducts are communicated through the opening 60.

More detail of an example embodiment of the hinge assembly 68 is shown in FIG. 6. As shown in FIG. 6, the hinge assembly 68 includes a pivoting connection 70 configured to facilitate rotation of the wall 66 about the axis A, and a tab 72 projecting outward and downward (relative to FIG. 6) from base 64 and configured to limit rotation of the wall 66 beyond the tab 72. The tab 72 is sized and shaped to correspond to the desired threshold rotation amount X.

As shown in FIG. 4, when vent byproducts are not communicated through the opening 60, the wall 66 lies in a plane P1 substantially perpendicular to the centerline C of the opening 60 and substantially parallel to the base 64 and the wall 62. Rotation of the wall 66 to the position of FIG. 5 is resisted by at least one retention clip 74 (FIG. 5) adjacent the second edge 69. While one retention clip is shown in FIG. 5, another retention clip could be arranged adjacent the first edge 67 and/or adjacent the second end 73, as examples. The retention clip 74 is configured to interface with a slot 76 in the base 64. The retention clip 74 and slot 76 are configured to resist rotation of the wall 66 to the open position and are configured such that, in order for vent byproducts to be communicated through the opening 60, the pressure of the vent byproducts must overcome the resistance brought about by the retention clip 74 interfacing with the slot 76.

When the pressure relief valve 58 is in the open position of FIG. 5, the wall 66 provides a portion of a vent duct. The wall 66 is configured to guide vent byproducts in a desired direction corresponding to the threshold rotation amount X. In FIG. 5, the threshold rotation amount X is substantially 45° relative to the wall, and the desired direction is vertically downward, substantially 90° relative to the centerline C of the opening 60.

When vent byproducts are communicated through the opening 60, the vent byproducts overcome the resistance of the at least one retention clip 74 and the hinge assembly 68 permits rotation of the wall to the position of FIG. 5. In FIG. 5, the wall 66 lies in a plane P2 oblique to (i.e., neither parallel to nor perpendicular to) the centerline C of the opening 60. The wall 66 is also transverse to the centerline C of the opening 60 (i.e., the centerline C passes through the wall 66). The hinge assembly 68 prevents the wall 66 from detaching altogether from the base 64 when vent byproducts are communicated through the opening 60.

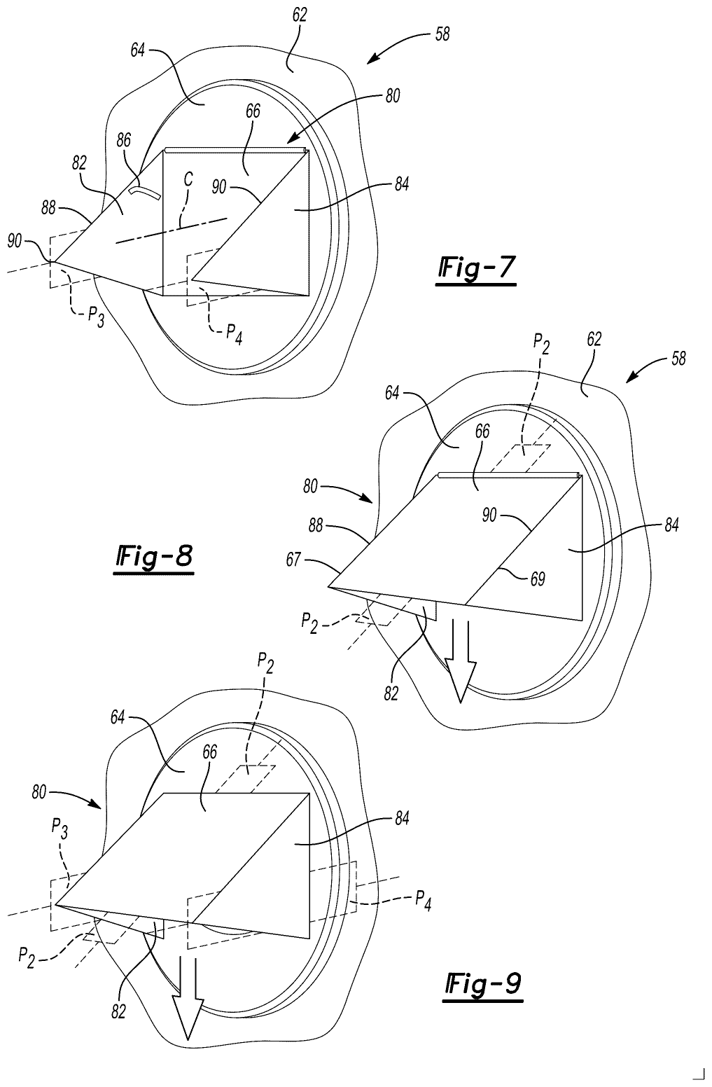

Another embodiment is shown in FIGS. 7 and 8. With reference to FIGS. 7-8, and with continued reference to FIGS. 1-6, battery pack 14 includes another example vent duct 80. The vent duct 80 includes the wall 66, as in the previous embodiment, but further includes a first side wall 82 and a second side wall 84. With the exception of the addition of the first and second side walls 82, 84, the pressure relief valve 58 is configured substantially as in the embodiment of FIGS. 4-6. The first and second side walls 82, 84 are rigidly mounted relative to the base 64. The first and second side walls 82, 84 are configured to remain stationary during operation of the pressure relief valve 58. The wall 66 is arranged between the first and second side walls 82, 84, and is moveable relative to the first and second side walls 82, 84. The first and second side walls 82, 84 lie in respective planes P3, P4 substantially parallel to the centerline C of the opening 60 and perpendicular to the base 64 and wall 62.

In one embodiment, the first and second side edges 67, 69 of the wall 66 are configured to directly contact a respective one of the first and second side walls 82, 84 when the pressure relief valve 58 is in the open position and the closed position.

In this embodiment, the first side wall 82 includes a catch 86. While one catch 86 is shown, the second side wall 84 could include a similar catch. Further, in embodiments with only one catch, the catch 86 could be provided on the second side wall 84 instead of the first side wall 82.

The catch 86 is configured to permit the wall 66 to rotate to the open position of FIG. 8. Further, the catch 86 is configured such that when the wall is in the open position of FIG. 8, the catch 86 holds the wall 66 in place and prevents the wall 66 from rotating back to the closed position of FIG. 7. In this regard, the catch 86 may be considered a one-way catch. The catch 86 may include a deflectable arm that is biased, by a spring or otherwise, to permit rotation of the wall 66 to the open position and to prevent the wall 66 from rotating back to the closed position once the wall 66 is in the open position.

Together with the hinge assembly 68, the catch 86 serves to maintain a position of the wall 66 such that the wall 66 lies in plane P2 by preventing movement of the wall 66 toward the opening 60.

When in the open position of FIG. 8, in this example, the first side edge 67 of the wall 66 is substantially adjacent a top (relative to FIG. 7) edge 88 of the first side wall 82, and the second side edge 69 of the wall 66 is substantially adjacent a top edge 90 of the second side wall 84. The top edges 88, 90 are substantially parallel to plane P2.

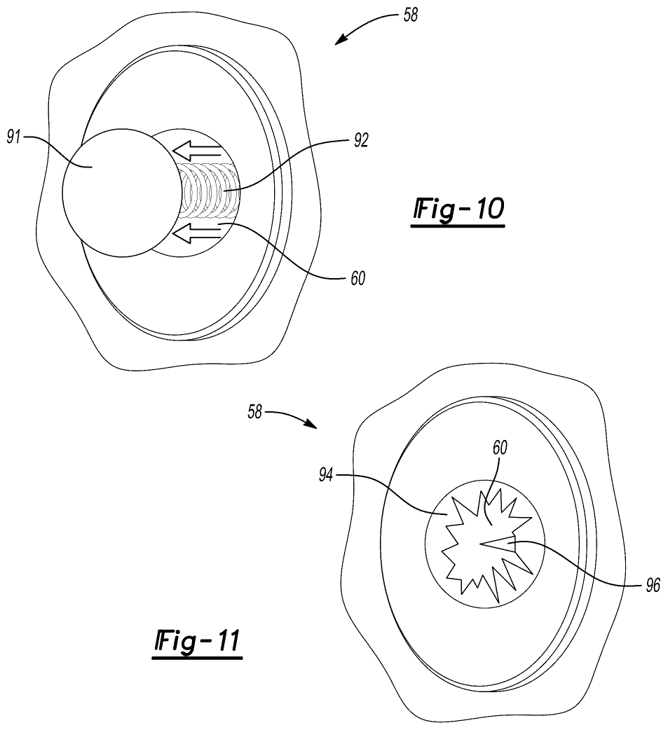

In another embodiment, shown in FIG. 9, the vent duct 80 is configured similar to embodiment of FIGS. 7 and 8, but the wall 66 is not moveable and is formed separately from the pressure relief valve 58, and in particular is formed separately from those structures that are configured to open and close the opening 60. Further, in FIG. 9, there is no hinge assembly, retention clips, or catch. Rather, the wall 66, the first side wall 82, and the second side wall 84 are rigidly formed, such as by being fixed to one another. The wall 66 and the first and second side walls 82, 84 are configured to remain stationary during operation of the pressure relief valve 58. More particularly, the wall 66, first side wall 82, and second side wall 84 are rigidly formed into the position of FIG. 8. While the wall 66, first side wall 82, and second side wall 84 are labeled separately, they could be provided by a single, integrated structure without any joints or seams. As above, the wall 66 is arranged in plane P2, and the first and second side walls 82, 84 are arranged in planes P3, P4. The vent duct 80 of FIG. 9 could be arranged relative to various types of pressure relief valves 58, including spring valves (FIG. 10) and membrane valves (FIG. 11). With respect to FIG. 10, the pressure relief valve 58 includes a wall 91 configured to close opening 60 until the vent byproducts overcome the force of the spring 92, which biases wall 91 closed. With respect to FIG. 11, the pressure relief valve 58 includes a membrane 94 configured to rupture when the vent byproducts cause a structure 96 to come into contact with the membrane 94. While two example pressure relief valves are shown, the embodiment of FIG. 9 couple apply to other types of pressure relief valves.

It should be understood that terms such as “about” and “substantially” are not intended to be boundaryless terms, and should be interpreted consistent with the way one skilled in the art would interpret those terms. Directional terms such as “above,” “upper,” “below,” “bottom,” etc., are used with reference to the arrangement of the corresponding components in the drawings and are not intended to otherwise be limiting.

Although the different examples have the specific components shown in the illustrations, embodiments of this disclosure are not limited to those particular combinations. It is possible to use some of the components or features from one of the examples in combination with features or components from another one of the examples.

One of ordinary skill in this art would understand that the above-described embodiments are exemplary and non-limiting. That is, modifications of this disclosure would come within the scope of the claims. Accordingly, the following claims should be studied to determine their true scope and content.

1. A battery pack, comprising:
an enclosure assembly providing an interior that houses at least one battery array;
a pressure relief valve configured to selectively communicate a flow of vent byproducts from the interior of the enclosure assembly to an exterior of the enclosure assembly via an opening; and
a vent duct including a wall, wherein, when vent byproducts are communicated through the opening, the wall lies in a plane oblique to a centerline of the opening.

2. The battery pack as recited in claim 1, wherein, when vent byproducts are communicated through the opening, the wall is transverse to the centerline of the opening.

3. The battery pack as recited in claim 2, wherein the wall provides at least a portion of the pressure relief valve and at least a portion of the vent duct.

4. The battery pack as recited in claim 3, wherein:
the wall is configured as a moveable flap and is moveable relative to the opening,
the wall covers the opening when vent byproducts are not communicated through the opening, and
the wall uncovers the opening when vent byproducts are communicated through the opening.

5. The battery pack as recited in claim 4, wherein, when vent byproducts are not communicated through the opening, the wall lies in a plane substantially perpendicular to the centerline of the opening.

6. The battery pack as recited in claim 5, further comprising:
at least one retention clip configured to resist movement of the wall when vent byproducts are not communicated through the opening, and wherein, in order for vent byproducts to be communicated through the opening, the pressure of the vent byproducts must overcome the resistance of the at least one retention clip.

7. The battery pack as recited in claim 6, further comprising:
a hinge assembly configured to permit the wall to rotate as vent byproducts are communicated through the opening.

8. The battery pack as recited in claim 7, wherein the hinge assembly is configured to restrict movement of the wall beyond a threshold rotation amount.

9. The battery pack as recited in claim 8, wherein:
the vent duct includes a first side wall and a second side wall,
the first and second side walls lie in respective planes substantially parallel to the centerline of the opening, and
the wall is arranged between the first and second side walls and is moveable relative to the first and second side walls.

10. The battery pack as recited in claim 9, wherein, when vent byproducts are communicated through the opening, side edges of the wall directly contact the first and second side walls.

11. The battery pack as recited in claim 10, wherein, when vent byproducts are communicated through the opening, a catch holds the wall in a position such that the wall lies in a plane oblique to a centerline of the opening.

12. The battery pack as recited in claim 11, wherein, when vent byproducts are communicated through the opening and the catch holds the wall in the position such that the wall lies in a plane oblique to a centerline of the opening, the catch prevents movement of the wall toward the opening.

13. The battery pack as recited in claim 2, wherein the wall is formed separately from the pressure relief valve and is configured to remain stationary while vent byproducts are communicated through the opening.

14. The battery pack as recited in claim 13, wherein:
the vent duct includes a first side wall and a second side wall,
the first and second side walls are fixed to the wall and arranged on opposite sides of the wall,
the first and second side walls lie in respective planes substantially parallel to the centerline of the opening.

15. The battery pack as recited in claim 14, wherein the pressure relief valve includes one of a spring valve and a membrane.

16. The battery pack as recited in claim 1, wherein the vent duct is configured such that the wall guides the vent byproducts that flow out of the opening in a direction away from the centerline of the opening.

17. A vent duct for a battery pack, comprising:
a wall configured such that, when vent byproducts are communicated through an opening of an enclosure assembly of the battery pack, the wall lies in a plane oblique to a centerline of the opening.

18. The vent duct as recited in claim 17, wherein the wall is transverse to the centerline of the opening.

19. The vent duct as recited in claim 17, wherein either (i) the wall is formed separately from a pressure relief valve and is configured to remain stationary while vent byproducts are communicated through the opening, or (ii) the wall provides at least a portion of a pressure relief valve and at least a portion of the vent duct.

20. A method, comprising:
guiding vent byproducts communicated through an opening of an enclosure assembly of a battery pack in a direction away from a centerline of the opening using a wall lying in a plane oblique to the centerline of the opening.
